(19) United States
(12) Patent Application Publication
(10) Pub. No.: US 2008/0210504 A1
(43) Pub. Date: Sep. 4, 2008

(54) Composite Brake Drum with Cgi Cast Liner and a Method for Manufacturing

(75) Inventors: Paul D. Levering, Cullman, AL (US); Jeremy L. Zills, Cullman, AL (US); John C. Hall, West Hoover, AL (US)

Correspondence Address: PATZIK, FRANK & SAMOTNY LTD., 150 SOUTH WACKER DRIVE, SUITE 1500, CHICAGO, IL, 60606, US

(73) Assignee: Webb Wheel Products, Inc., Cullman, AL (US)

(21) Appl. No.: 11/997,853

(22) PCT Filed: Aug. 3, 2006
(86) PCT No.: PCT/US2006/030172

§ 371 Date: Feb. 4, 2008

Related U.S. Application Data
(60) Provisional application No. 60/705,250, filed on Aug. 3, 2005.

(51) Int. Cl. F16D 65/10; B23P 17/00

(52) U.S. Cl. 188/218 R; 29/527.5

(57) ABSTRACT

A vehicle composite brake drum (10) is provided and includes a brake drum shell (12), and a brake drum liner (22), the brake drum liner (22) is formed of compacted graphite iron. A method of manufacturing the vehicle composite brake drum includes forming a brake drum shell and then forming a brake drum liner of compacted graphite iron.

### CROSS-REFERENCE TO RELATED APPLICATION

This application claims the benefit of U.S. Provisional Application No. 60/705,250, filed Aug. 3, 2005.

### FIELD OF THE INVENTION

The invention relates, generally, to vehicle wheel assemblies used in vehicles such as trucks, buses and trailers, and more particularly, to a composite brake drum and a method of manufacturing the same.

### BACKGROUND OF THE INVENTION

The prior art vehicles include various brake systems for slowing or stopping a vehicle, such as medium and heavy-duty trucks, trailers and buses. The brake system may include a disc brake assembly or a drum brake assembly. The disc brake assemblies include a rotor, which rotates with the wheel and tire, and a caliper having brake pads. The brake pads straddle the rotor and are actuated by hydraulics or air to close upon the rotor and impart friction force to slow or stop the rotation of the rotor. Drum brake assembly includes a drum, which rotates with the wheel and tire, and brake shoes located within the drum. The brake shoes each have a brake pad which faces the interior annular wall of the drum and are hydraulically or air actuated to engage the drum annular wall to impart friction force to slow or stop the rotation of the brake drum.

Prior art brake drums include full cast drums of one material. The prior art drums also include composite drums. Composite drums include a drum which may be initially formed from a steel sheet via one of several different manufacturing methods, including spinning, flow forming and press fit. The brake drum lining may be centrifugally cast using various materials, such as high carbon steel, alloy steel, and grey iron structure.

U.S. Pat. No. 1,876,354 issued to Sinclair and discloses a composite brake drum. The brake drum is pressed or drawn sheet metal cup-shaped drum. The lining is formed of material, such as cast iron, high carbon-steel, alloy steel or the like. U.S. Pat. No. 2,080,895 issued to Nelson and discloses a method of making a brake drum and drum seal. The brake ring portion is preferably formed from sheet metal and is provided with a cast metal liner. U.S. Pat. No. 5,138,757 issued to Ballet al and discloses a process for manufacturing a vehicle brake drum. The drum is formed from sheet steel stock and rolled. Grey iron structure is then centrifugally cast within the drum to form a composite brake ring. U.S. Pat. No. 6,572,712 issued to Powell et al. and discloses a compacted graphite iron brake drum. FIGS. 1 and 2 show a brake drum cast as an integral structure. The brake drum includes a base portion and a wall depending from the base portion.

### SUMMARY OF THE INVENTION

It is an object of the present invention to provide a brake drum which has an increased drum life, particularly as to the wear life.

It is an object of the present invention to provide a brake drum which has an increased drum life, particularly as to the structural life.

It is a further object of the present invention to provide a brake drum which will accommodate shorter vehicle stopping distances, by providing a more aggressive brake lining with a harder drum wear surface.

The present invention therefore provides in one embodiment, a vehicle brake drum comprising a brake drum shell, and a brake drum liner, the brake drum liner formed of compacted graphite iron.

The present invention further provides in another embodiment, a method of manufacturing a composite brake drum, the method comprising the steps of forming a brake drum shell, and forming a brake liner of compacted graphite iron.

### BRIEF DESCRIPTION OF THE DRAWINGS

FIG. 1 is a perspective view of a brake drum in accordance with the present invention.

FIG. 2 is a cross-sectional side view of the drum of FIG. 1.

FIG. 3 is a cross-sectional side view of the drum of FIG. 1, but prior to centrifugally casting the brake liner.

FIG. 4 is a process for manufacturing the brake drum of FIG. 1.

### DETAILED DESCRIPTION OF THE INVENTION

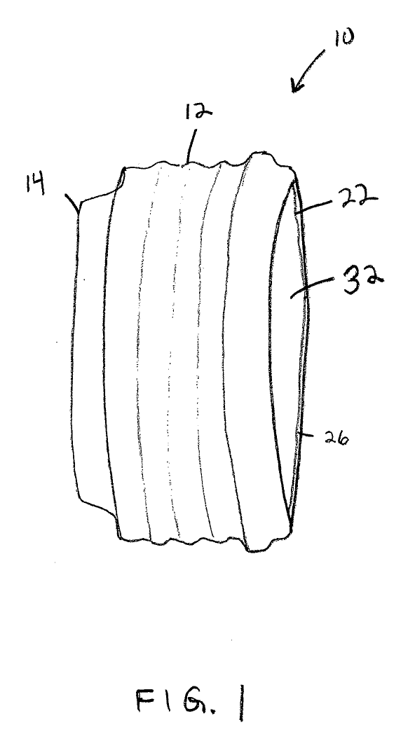

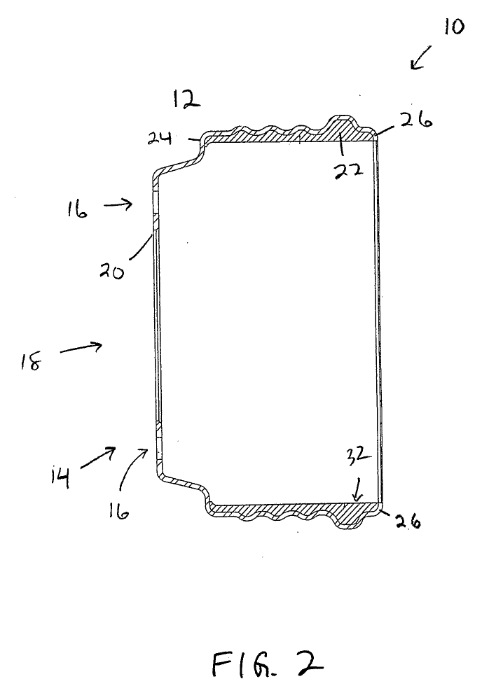

FIG. 1 shows a perspective view of the brake drum 10 in accordance with the present invention. The brake drum 10 depicts a typical brake drum for mounting at the rear of a vehicle. However, the present invention is also applicable to front-mounted brake drums. The brake drum 10 includes a drum shell 12 and a mounting flange 14. FIG. 2 is a cross-sectional view of the brake drum 10 of FIG. 1. The mounting flange 14 includes a plurality of lug bolt mounting holes 16 and a hub mounting hole 18 with an edge 20 which abuts against the drum pilot on the hub (not shown). The brake drum liner 22 is shown and is comprised of compacted graphite iron (CGI).

Referring particularly to FIG. 2, in an area where the drum shell and mounting flange 14 converge, the brake drum includes an outboard, upturned flange 24 directed radially inward. The brake drum 10 includes an inboard, upturned flange 26 which is also directed radially inward.

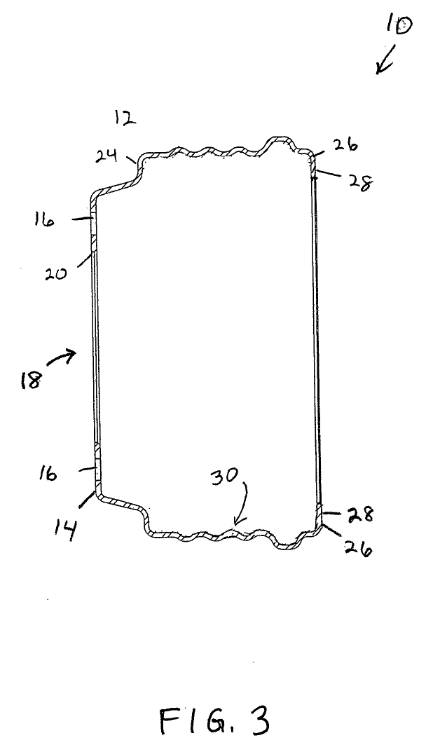

FIG. 3 is a cross-sectional view of the brake drum of FIGS. 1 and 2, but prior to the centrifugal casting of the brake drum liner 22. The inboard, upturned flange 26 is shown to include an extension portion 28. The upturned flange 24 and the upturned flange 26 with extension portion 28 form a cavity 30. The cavity 30 accommodates the brake liner 22.

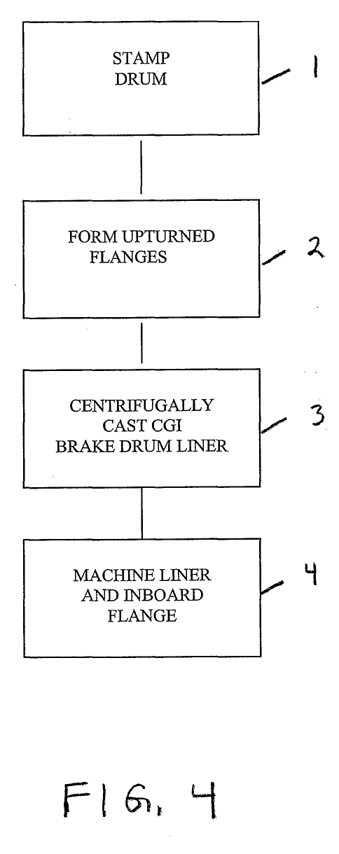

FIG. 4 is a flow chart of the process for manufacturing the brake drum 10 of FIG. 1. Step 1 consists of stamping a steel blank into a drum. Step 2 consists of spin-forming, flow-forming or other known techniques, to better define the drum and the inboard and outboard upturned flanges 24, 26, including the extension portion 28. Step 3 consists of centrifugally casting the brake liner of CGI, within the cavity 30 of the shell 12. Step 4 consists of machining the brake drum liner 22 and extension portion 28 to form the brake surface 32.

The brake drum 10 shown in FIG. 1 is a one-piece brake drum shell and mounting flange. In another embodiment, the drum may be formed from a separate brake drum shell and a separate mounting flange wherein the mounting flange is secured to the brake drum shell. The step of securing the mounting flange to the brake drum shell may be via welding.

What is claimed:

1. A vehicle composite brake drum comprising:
a brake drum shell; and
a brake drum liner, the brake drum liner formed of compacted graphite iron.

2. The vehicle brake drum of claim 1, wherein the brake drum is formed of steel.

3. The vehicle brake drum of claim 2, wherein the brake drum is formed by a spin step.

4. The vehicle brake drum of claim 1, wherein the drum includes a closed end mounting flange having lug bolt mounting holes and a hub mounting hole.

5. The vehicle brake drum of claim 4, wherein the brake drum shell and mounting flange form a one piece drum.

6. The vehicle brake drum of claim 4, wherein the brake drum shell includes a mounting flange secured to a drum shell.

7. The vehicle brake drum of claim 6, wherein the mounting flange is welded to the drum shell.

8. A method of manufacturing a composite brake drum, the method comprising the steps of:
forming a brake drum shell; and
forming a brake drum liner of compacted graphite iron.

9. The method of claim 8, wherein the step of forming the brake drum liner includes centrifugally casting the compacted graphite iron within the brake drum shell.

10. The method of claim 8, wherein the step of forming the brake drum shell includes spin forming the brake drum shell from sheet steel.

11. The method of claim 8, wherein the step of forming the brake drum shell includes forming a one piece brake drum shell and mounting flange.

12. The method of claim 8, wherein the step of forming the brake drum shell includes the step of forming a brake drum shell, forming a mounting flange, and securing the mounting flange to the brake drum shell.

13. The method of claim 12, wherein the step of securing includes welding the mounting flange to the brake drum shell.

14. The method of claim 8, wherein the step of forming the brake drum shell includes the step of stamping a brake drum shell from a blank of steel.

15. The method of claim 8, wherein the step of forming the brake drum shell includes forming an outboard upturned flange and an inboard upturned flange, the inboard upturned flange having an extension portion.

16. The method of claim 15, wherein the step of forming the brake drum liner includes machining the brake drum liner and extension portion to form the brake surface.
